(19) United States
(12) Patent Application Publication
(10) Pub. No.: US 2014/0108031 A1
(43) Pub. Date: Apr. 17, 2014

(54) SYSTEM AND METHOD FOR INCREASING MEDICATION ADHERENCE RATES

(71) Applicant: DANIEL FERRARA, Morristown, NJ (US)

(72) Inventor: DANIEL FERRARA, Morristown, NJ (US)

(21) Appl. No.: 13/864,197

(22) Filed: Apr. 16, 2013

Related U.S. Application Data
(63) Continuation-in-part of application No. 13/339,484, filed on Dec. 29, 2011.
(60) Provisional application No. 61/624,583, filed on Apr. 16, 2012.

(51) Int. Cl. G06F 19/00; G06Q 30/02

(52) U.S. Cl. CPC G06F 19/3456; G06Q 30/0207
USPC 705/2

(57) ABSTRACT

Embodiments of the present disclosure generally relate to a system and method for increasing medication adherence rates. In embodiments, a method of increasing medication adherence rates may comprise enabling a user to download an application to a mobile device via a network, the application comprising a set of instructions for permitting a user to access a medication reminder means for providing a reminder to the user to follow prescribed instructions regarding medication; an adherence tracking means for tracking the user's compliance with the prescribed instructions; a prescription price compare means adapted to provide the user a list of prices for a medication prescribed to the user; and receiving data from the mobile device at a remote server via the network, the data comprising information from the medication reminder means and the adherence tracking means.

### CROSS-REFERENCE TO RELATED APPLICATIONS

This application is a continuation-in-in part of U.S. patent application Ser. No. 13/339,484, entitled “System and Method for Increasing Medication Adherence Rates,” filed Dec. 29, 2011, which claims priority to U.S. Provisional Application Ser. No. 61/428,904, entitled “System and Method for Increasing Medication Adherence Rates,” filed Dec. 31, 2010; and this application claims priority to U.S. Provisional Application Ser. No. 61/624,583, entitled “System and Method for Increasing Medication Adherence Rates,” filed Apr. 16, 2012, the disclosures of which are incorporated herein by reference in their entireties.

### BACKGROUND

1. Field of the Invention

Embodiments of the present disclosure generally relate to a system and method for increasing medication adherence rates. More specifically, embodiments of the present invention relate to a system and method for decreasing global health care costs by monitoring, reminding, and facilitating medication adherence utilizing mobile communication devices.

2. Description of Related Art

The extent to which individuals take their medications as prescribed by their doctor is known as medication adherence. Failure to take medications as prescribed is termed nonadherence. Medication nonadherence, either willful or inadvertent, can include: failing to initially fill or refill a prescription, discontinuing a medication before the course of therapy is complete, taking more or less of a medication than prescribed and/or taking a dose at the wrong time.

The consequences of medication nonadherence in older adults may be more serious, less easily detected, and less easily resolved than in younger age groups. If medication nonadherence were a disease, it could be termed an epidemic. Medication nonadherence accounts for more than 10% of all hospital admissions, nearly one-fourth of nursing home or elder patient hospital admissions, and 20% of preventable adverse drug events among older persons in the ambulatory setting. It is estimated that medication nonadherence results in 125,000 deaths annually, and costs the US health care system $100 billion per year.

It is estimated that almost 25% of employers' healthcare expenses are a direct consequence of medication non-adherence. The following Table 1 is an example of how much medical adherence versus nonadherence costs insurance companies for three select diseases, and 100 patients diagnosed with each disease:

TABLE 1
Source: Managed Care, February 2000

| | Non- | | Every 100 Patients |
|---|---|---|---|
| | Adherent | Adherent | Moved to Adherent Saves |
| Diabetes | $8,612 | $3,808 | $500,400/yr |
| Depression | $6,000 | $4,800 | $120,000/yr |
| Cholesterol | $6,810 | $3,124 | $368,600/yr |
| | | | $989,000 |

Accordingly, there is a need for a system and method for increasing medication adherence rates.

### SUMMARY

Embodiments of the present disclosure generally relate to a system and method for increasing medication adherence rates. More specifically, embodiments of the present invention relate to a system and method for decreasing global health care costs by monitoring, reminding, and facilitating medication adherence utilizing mobile communication devices.

In one embodiment of the present invention, a method of increasing medication adherence rates comprises: enabling a user to download an application to a mobile device via a network, the application comprising a set of instructions for permitting a user to access: a medication reminder means for providing a reminder to the user to follow prescribed instructions regarding medication; and an adherence tracking means for tracking the user's compliance with the prescribed instructions; and receiving data from the mobile device at a remote server via the network, the data comprising information from the medication reminder means and the adherence tracking means.

In another embodiment of the present invention, a method of increasing medication adherence rates comprises: enabling a user to download an application to a mobile device via a network, the application comprising a set of instructions for permitting a user to access: a medication reminder means for providing a reminder to the user to follow prescribed instructions regarding medication; a patient support means for providing the user information pertaining to one of a medication, disease or treatment thereof; a sponsor alert means for providing portions of data to a third party sponsor, and permitting the sponsor to engage in marketing or advertising; a personal health record means for compiling the user's personal health information; and an adherence tracking means for tracking the user's compliance with the prescribed instructions; and receiving the data from the mobile device at a remote server via the network, the data comprising information from the medication reminder means and an adherence tracking means.

In yet another embodiment of the present invention, a method of increasing the effectiveness of direct marketing for sponsors comprises: enabling a user to download an application to a mobile device via a network, the application comprising a set of instructions for permitting a user to access: a reminder means for providing a reminder to the user to follow prescribed instructions regarding a particular task; a sponsor alert means for providing portions of the data to a third party sponsor, and permitting the sponsor to engage in marketing or advertising directly to the mobile device; an adherence tracking means for tracking the user's compliance with the prescribed instructions; and receiving data from the mobile device at a remote server via the network, the data comprising information from the reminder means and the adherence tracking means.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a system-level network diagram of a system for increasing medication adherence rates in accordance with one embodiment of the present invention;

FIG. 2 depicts a block diagram of a general computer system, capable of being utilized in connection with the system depicted in FIG. 1, in accordance with another embodiment of the present invention;

FIG. 3 depicts a system level diagram for communication between a user and an administrator in accordance with one embodiment of the present invention; and

FIG. 4 depicts a flowchart of a method for utilizing a system for increasing medication adherence rates in accordance with one embodiment of the present invention;

FIG. 5 depicts a flowchart of a method of engaging a health assistant portal in accordance with one embodiment of the present invention;

FIG. 6 depicts an exemplary alert in accordance with one embodiment of the present invention; and

FIG. 7 depicts a flowchart of a method of marketing via a sponsor alert tool in accordance with one embodiment of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean “including but not limited to.” To facilitate understanding, like reference numerals have been used, where possible, to designate like elements common to the Figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

Embodiments of the present disclosure generally relate to a system and method for increasing medication adherence rates. More specifically, embodiments of the present invention relate to a system and method for decreasing global health care costs by monitoring, reminding, and facilitating medication adherence utilizing mobile communication devices.

Also, as used herein, the term “multimedia data” refers to any type of data that may reasonably be construed as a media data type, including specifically, audio data (e.g., sound bites, music, or the like), visual data (e.g., photographs, graphics, videos, or the like), text data (e.g., as entered by a user from an input device), barcode data (e.g., as commonly found on labels, reciepts or the like), radio frequency identification (RFID) data, geographic and/or directional data (e.g., as reported from a Global Positioning System (GPS) or a preprogrammed routing source, often in the form of coordinates, or relationship positioning), or the like. As understood by the embodiments disclosed herein, any discussion of one particular form of multimedia data shall be inclusive of any other type of multimedia data as defined above.

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

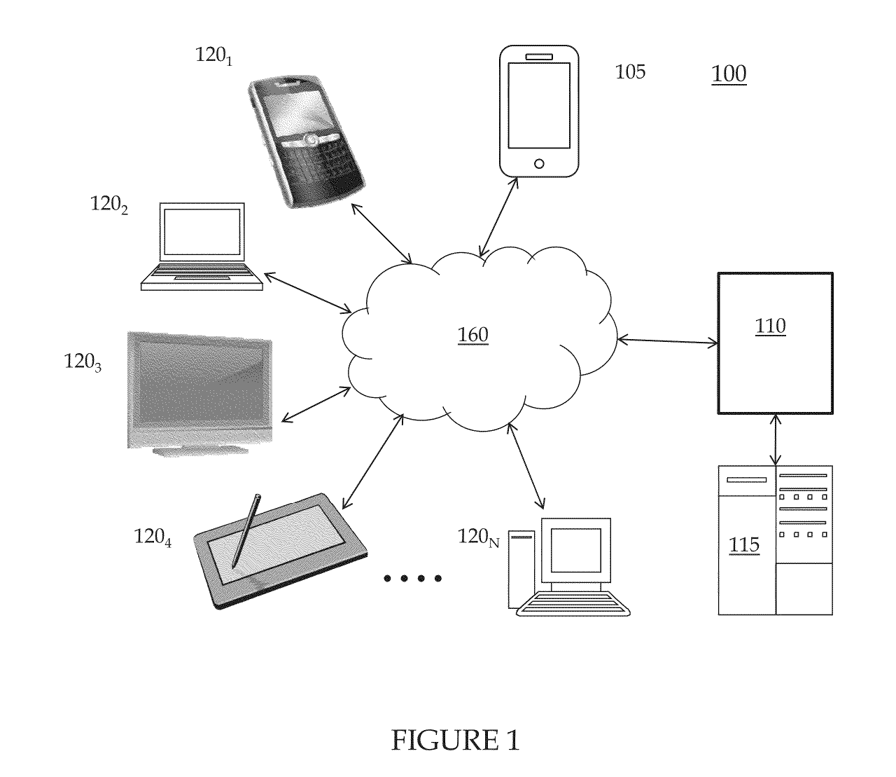

FIG. 1 depicts a basic system-level diagram of a system for increasing medication adherence rates in accordance with one embodiment of the present invention. The system 100 generally comprises at least a first user 105 in communication with an administrator 110 or host, generally hosting a central server 115 or a remote server, having a database, through a network 160. In accordance with one or more embodiments of the present invention, the network 160 generally comprises a global computer network, for example, the Internet.

The system 100 may also comprise a number of secondary users (e.g., labeled 120₁, 120₂, 120₃, 120₄ and 120_{N}), which may comprise any other individuals or patients in communication with the administrator 110 at any given time. It should be appreciated that N represents any number of secondary users feasible in accordance with embodiments of the present invention.

The first user 105 generally has been diagnosed with a condition or disease, and has a prescribed schedule for taking one or more particular medications. Alternatively, in other embodiments, the first user 105 may have an interest in a condition, disease or medication for any number of reasons. For example, the first user 105 may have a real interest in the condition (e.g., a relative of the first user is diagnosed with such condition). In another exemplary embodiment, the first user 105 may have an interest in an attribute of the condition (e.g., learning about the side effects of a particular drug used to treat such condition).

In a basic exemplary embodiment, within the system 100, a first user 105 may be capable of transmitting data regarding the event to the administrator 110, using a computer device. The computer device in the context of this application may include, but is not limited to, any mobile device, such as a mobile phone, an Apple iPhone, a Blackberry device, a smartphone, a Personal Data Assistant (PDA), a tablet (e.g., an Apple iPad), an Internet appliance or the like. Similarly, a computer device may comprise a laptop, desktop, netbook, or may generally include a general purpose computer, as discussed below. In certain embodiments, the computer device may comprise an interactive television (e.g., a web TV, whereby the television is capable of interacting through a network with another party).

As explained above, the network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

Optionally, a third party commercial server (not shown) may be in communication with the system 100 through the network 160 to carry out certain features of embodiments of the present invention, as explained below. In accordance with embodiments of the present invention, such third party commercial servers may be administered by financial institutions (e.g., banks, credit card companies, or the like), advertisers (e.g., any third party offering banner ads or displayed offers), local merchants (e.g., pharmacists, retailers), social networking sites (e.g., Facebook, MySpace, Twitter, or the like), global positioning system administrators, server farms (for third party hosting of the administrator described herein, or for cloud computing systems), or the like.

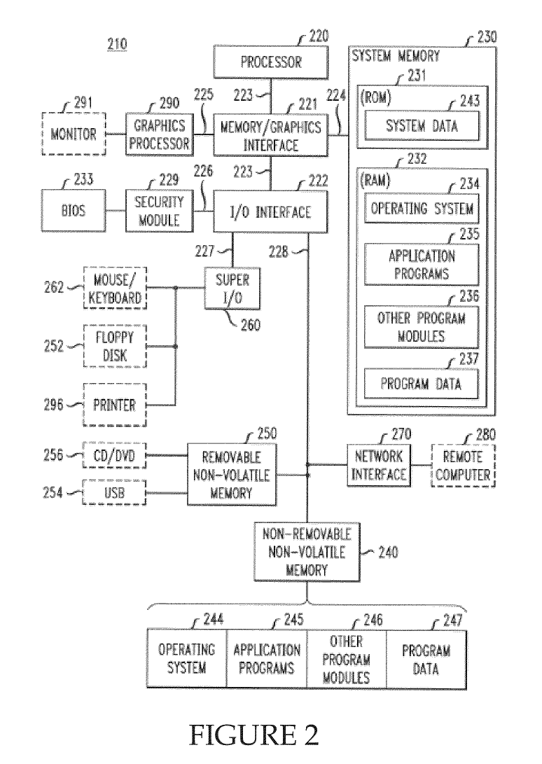

In accordance with one embodiment of the present invention, any of the administrator or users may comprise a general purpose computer, for example, as shown in the form of a computer 210 depicted in FIG. 2. As appreciated by embodiments of the present invention, more practical devices, such as mobile devices, mobile telephones, or the like, are likely to be utilized than a general computer 210 for embodiments of the present invention. However, it is also appreciated there is a significant similarly in core components between a mobile device and a general computer 210. The following components are described for exemplary purposes only, and each component's mobile equivalent is also contemplated within embodiments of the present invention.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

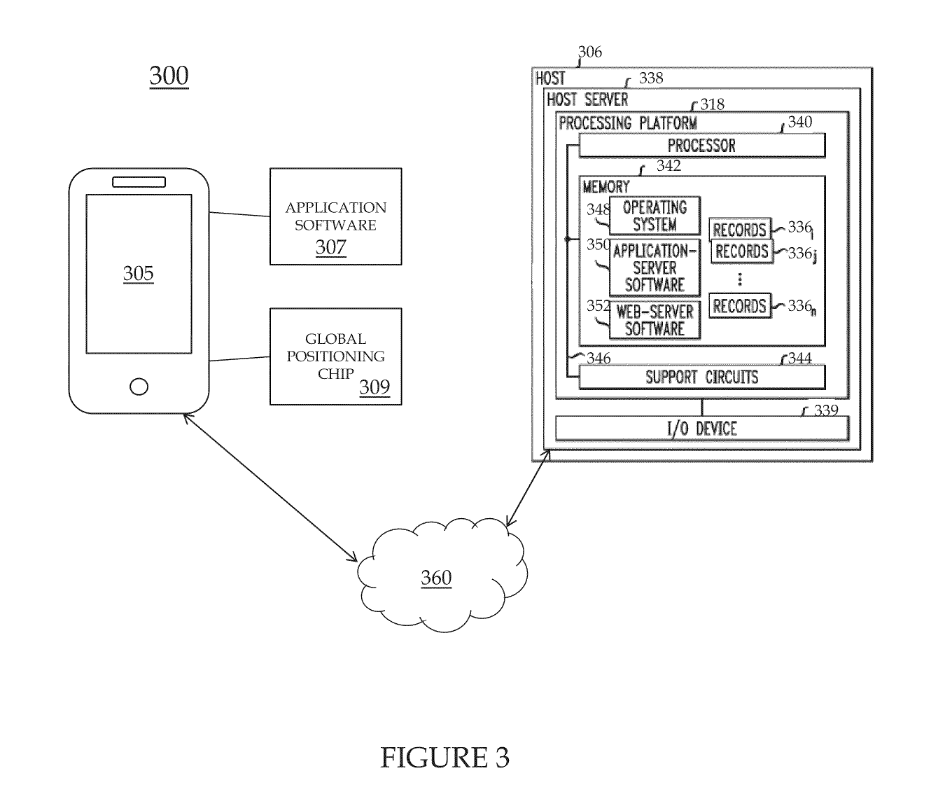

FIG. 3 depicts a system of communication between a user and an administrator in accordance with one embodiment of the present invention. As shown in the Figure, a user 305 generally comprises a computer device, for example, a mobile phone or a smart phone. The user 305 may also generally comprise application software 307 and a global positioning chip 309. Other I/O components, which are common to computer devices, mobile phones and smart phones may also be provided but are not described in detail herein as they are well known in the industry.

As shown, the user 305 may include application software 307 that is operable to interact through the network 360 with the administrator or host 306 to allow the user to engage in the functionality as disclosed herein. Generally, the application software 307 may be obtained from any source, for example, through a third party website or application. In one specific example, the third party application for allowing the user 305 to download the application software 307 may be the application made commercially by Apple, Inc., under its “iTunes” trademark. Other similar means of obtaining the application software 307 are readily known in the industry.

In alternative embodiments, the application software 307 may be stored by the administrator and accessed through the network 360 when used by the user 305. For example, the application software 307 may be available as streaming information, whereby a web browser (not shown) or similar program is utilized to communicate with the administrator 306 and engage in the functionality disclosed herein.

The user 305 may also comprise a global positioning chip 309 and accompanying software, to enable the user 305 to obtain an accurate physical location of the user, or at least the user's computer device, when requested. The location information obtained through the global positioning chip 309, through a global positioning system (not shown), may be transmitted to the administrator 306 to facilitate certain functions of the system described herein.

The network 360 may be similar to the network 160 as shown in FIG. 1 above, and may comprise any type of computer network or data network suitable for embodiments of the present invention.

The administrator or host 306 may include one or more servers, including a host server 338. The host server 338 may be deployed in one or more general or specialty purpose computers, personal computers, mainframes, minicomputers, server-type computers, such as the general purpose computer shown in FIG. 2, and/or any a processor-based platform that operates on any suitable operating system, such as Microsoft® Windows® and/or Linux; and that is capable of executing software.

The host server 338 may include a large number of elements; most of which are not shown in FIG. 3 for simplicity of exposition. The elements of host server 338 may be formed in a single unitary device and concentrated on a single server, client, peer or other type node. Alternatively, the elements of the host server 338 may be formed from two or more separate devices, and as such, may be distributed among a number of server, client, peer or other type nodes.

The host server 338 may be deployed in accordance with the scale-up and/or scale-out approaches. Using the scale-up approach, the host server 338 may increase its processing power, amount of memory and number of networkable connections by utilizing a symmetrical, multi-processor architecture so as to provide additional capacity. A benefit of this scale-up approach is that such approach provides for simplified configuration and management as compared to the scale-out approach. Using the scale-out approach, the host server 338 may increase its processing power, amount of memory and number of networkable connections by incrementally adding and/or removing capacity as needed, balancing workload across multiple processors, multiple servers, dedicating specific processors and/or servers for performing specific tasks, using physical or logical servers (e.g., a multi-node cluster approach), etc.

As shown, the host server 338 includes one or more processing units (collectively “processor”) 340, memory 342, supports circuits 344 and bus 346. The processor 340 may be one or more conventional processors, microprocessors, multi-core processors, microcontrollers and the like.

The bus 346 provides for transmissions of digital information among the processor 340, memory 342 and support circuits 344 and other (not shown) portions of the host server 338. The support circuits 344 facilitate operation of the processor 340, and may include well-known circuitry or circuits, including, for example, one or more input/output I/O interfaces; one or more NIUs; cache; clock circuits; power supplies and the like.

The I/O interface provides an interface to control the transmissions of digital information among (shown and not shown) components of host server 338. In addition, the I/O interface provides an interface to control the transmissions of digital information among I/O devices 339 associated with or otherwise attached to the host server 138. The I/O devices 339 may be embodied as any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) a pointing device, such as a mouse, joystick, trackball, touchpad, pointing stick, light pen, head pointer, soap mouse, eye tracking devices, digitizing tablet and stylus, data glove that translates the user's movements to computer gestures; (vii) a key-in device, such as a keyboard or a touchpad, (viii) and the like.

The NIUs facilitate exchange (e.g., sending and/or receiving) of content. Accordingly, the NIUs may be adapted for communicating over terrestrial wireless, satellite, and/or wireline media.

The memory 342 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like. The memory 324 may store and/or receive requests from the processor 340 to execute various software packages, such as operating system 348, application-server software 350 and web-server software 352.

Additionally, the memory 342 may store and/or receive requests from the processor 340 to obtain the records 336ᵢ-336ₙ(e.g., copies thereof). As above, each of the records 136ᵢ-136ₙ may be stored as or in a single file or a plurality of files, and may be structured as text, a table, a database, a distributed hashtable, a distributed concurrent object store, a document formed using a markup or markup-like language, and the like. The records 136ᵢ-136ₙ may be stored, for example, using a Microsoft SQL Server and accessible through an ODBC connection.

Like the records 336ᵢ-336ₙ, the memory 342 may store and/or receive requests from the processor 340 to obtain operands, operators, dimensional values, configurations, and other data that are used by the various software packages to control the operation of and/or to facilitate performing the functions of the host server 338 and/or the host 306.

The application-server software 350, when executed by the processor 340, is operable to (i) communicate with the user 305, via the network 360, to obtain the information regarding the user 305, a pharmacist (not shown), a doctor (not shown) or the like, and store it as record 336ⱼ; and facilitate the features of the system as described herein based on the information stored in record 336ⱼ associated with the user 305. In addition, the application-server software 350, when executed by the processor 340, is operable to enable interaction between the users within a virtual set group as described herein.

The web-server software 352, which may be optional, when executed by the processor 340, is operable provide on one or more network or web-accessible pages to allow the user 305 to access information stored on the host server 338. For example, web-server software 352 may provide a data portal, having a graphical user interface, through which a user 305 may access the application-server software 350 and the functionality thereof. In such an embodiment, the application software 307 of the user 305 may only comprise a web browser or similar application for viewing the content of the web-server software 352 through the network 360.

It should be appreciated by embodiments of the present invention, although only one user 305 is shown, other users may access the administrator 306 in a similar fashion, such that a plurality of users can co-exist in communication with the administrator 306 through the network 360.

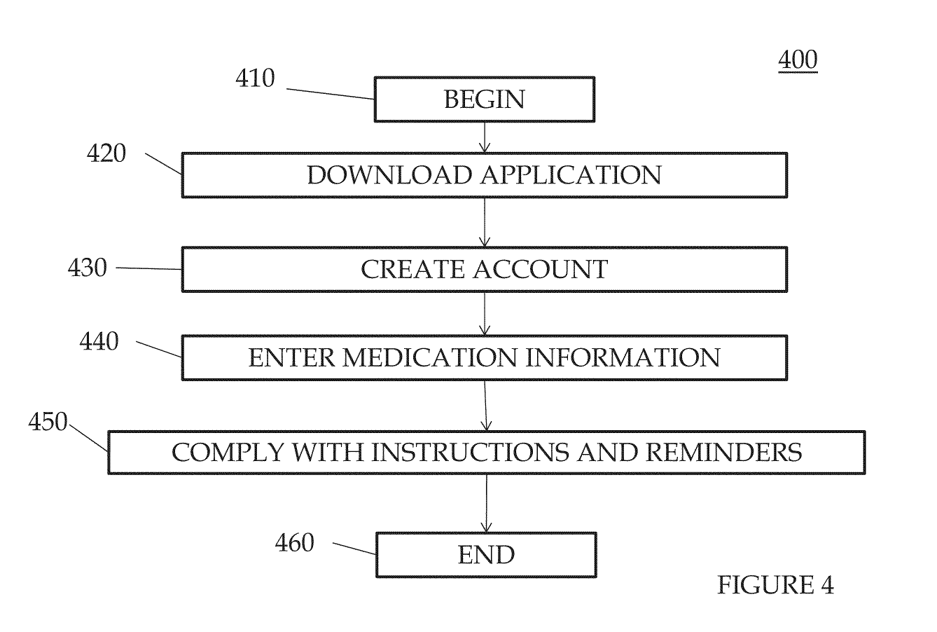

FIG. 4 depicts a flowchart of a method for utilizing a system for increasing medication adherence rates in accordance with one embodiment of the present invention. The method 400 beings at step 410. At step 420, a user of the system may download and/or access the application. In many embodiments, where a user is utilizing a mobile device, the user may log into a download portal, or “store” to acquire a software application, such software application comprising instructions to facilitate one or more of the methods contained herein. In an alternative embodiment, the application may be stored in a remote location, such as a cloud server, whereby a user can access the application via network access.

At step 430, a user may create his/her account within the system. Generally, a user may have the ability to provide a plurality of personal information in this step. For example, in many embodiments, it may be required to provide the user's contact information, including email, mailing address, telephone number(s), mobile/SMS contact information, and the like. As with many confidential or private systems, a user may also create a username and/or password for accessing the system at a later date.

At step 440, the user may provide information or medical data regarding their health, a condition, medications, schedule for medications, doctor appointments, vaccination schedules, prescription details (e.g., quantity of doses, refill information, etc.) and the like. In one exemplary embodiment, certain aspects of the initial setup can be done quasi-manually. For example, a user may first select a medication name (brand or generic) by typing the information off the prescription label. As the user types, the list may narrow, so the medication may be selected—in an attempt to minimize typographical errors. In such an embodiment, the list may be updated by an administrator with new information that is supplied independently and through the addition of medications not on the list that the user enters (if not on the list). Under such circumstances, the “new” medication is shown on an administrative screen, enabling the administrator to research the medication and indications and add it to the library.

In another embodiment, medical data can also be imported into the user's record through an application program interface, enabling linkage with PBM (Pharmacy Benefit Managers), Payers (Insurance Companies) or other external sources. For example, in one embodiment, medical data may be obtained from the PDX Pharmacy System, enabling access and interaction with the system for auto-population of health information within the user's record. Such interfaces may assist with the enablement of tracking adherence data, notifications to the user, etc.

In many embodiments, when providing information, a user may also have the ability to customize the types of medication reminders, view patient and sponsor promotional links, view and edit PHR information for emergency purposes (e.g., for an Emergency Health Record (EHR)), and the like. When considering customization, the user may be able to select frequency, type, sound, color, content, promotion, etc., affiliated with each reminder/alert. The details of such types of reminders and alerts are disclosed herein.

As described in detail herein, the system may provide numerous alerts, instructions, or the like. At step 450, the user complies with the instructions and/or reminders as they are received by the user. Generally, such instructions and/or reminders will be received by electronic message (e.g., email, SMS, MMS, or the like). In many embodiments, the instructions and/or reminders merely notify the user of an action to take, such as taking medication, refilling prescriptions, calling a doctor, looking at a website or other source of information, or the like. The method 400 ends at step 460. It should be noted, however, in most embodiments, the steps of accessing the system and complying with the instructions and/or reminders may continue as long as the user desires to be part of the system.

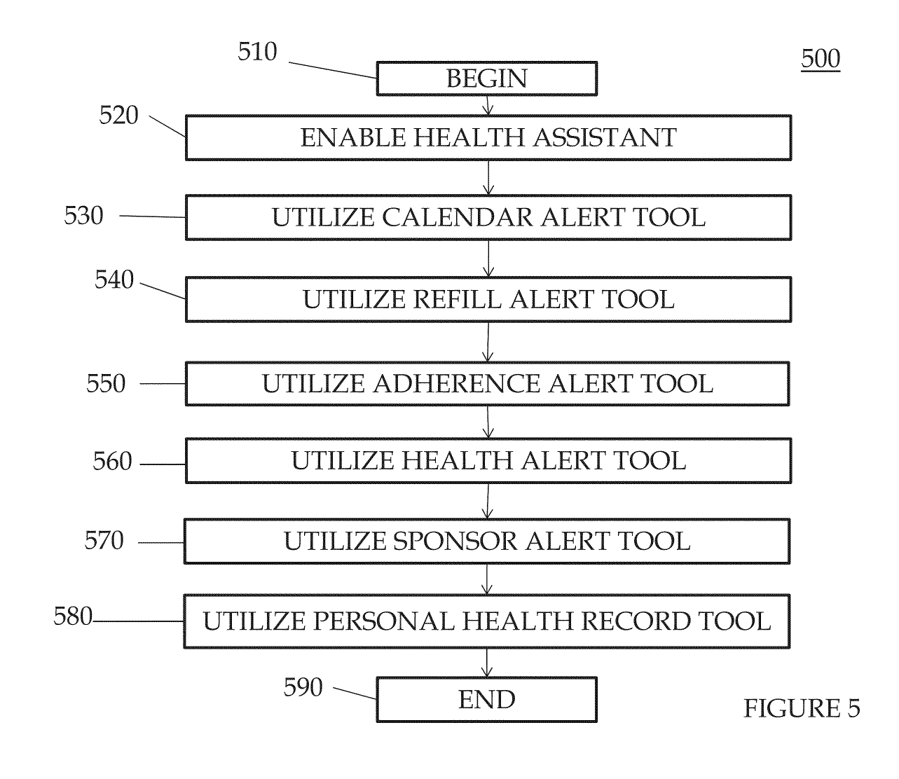

FIG. 5 depicts a flowchart of a method of engaging a health assistant portal in accordance with one embodiment of the present invention. The method 500 begins at step 510. At step 520, when the user engages the application, as described hereinabove with FIG. 4, the user may engage a health assistant component of the application. In general, the health assistant comprises a plurality of functional components or features therein. In one embodiment, the health assistant may comprise any number of applications suited for medication reminding, adherence tracking, disease education, social network interaction, patient support, outcome tracking and/or other related features. Many embodiments of the present invention encompass a plurality of combinations of such valuable tools utilized to facilitate an increase in medication adherence.

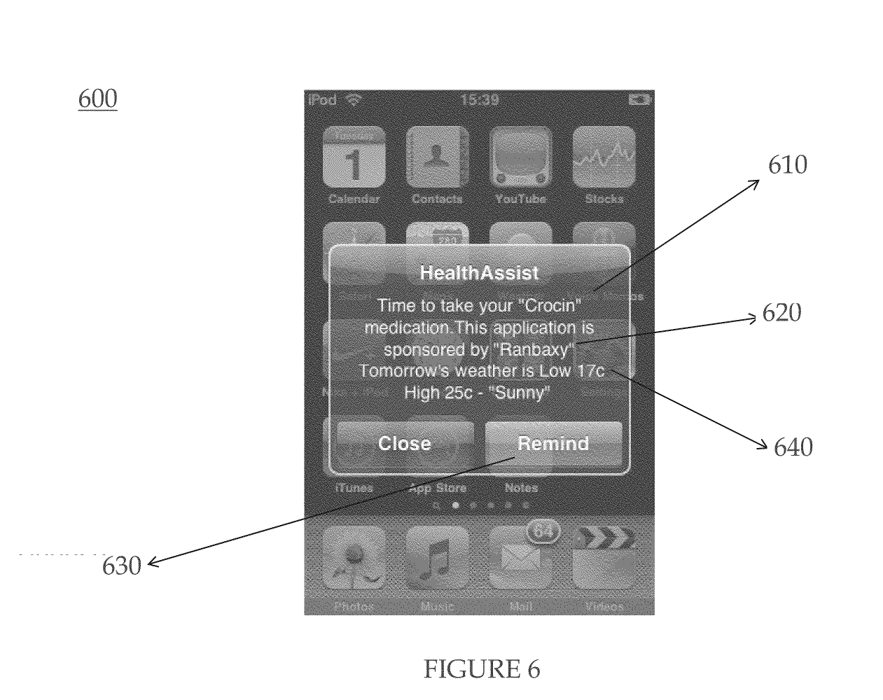

In one exemplary embodiment, the health assistant comprises a medication reminding tool and/or a tool to remind a patient when a refill may be coming due. At step 530, a user may utilize a calendar alert tool that he/she needs to take certain medication, get a refill, etc. FIG. 6 depicts an exemplary alert in accordance with one embodiment of the present invention.

As shown in the Figure, a screenshot of a mobile device may show an alert 600. The alert (e.g., a text message, a pop-up message, an email, a chime, combinations thereof, or the like) may be presented to the patient each day reminding them to take their specific medication 610. Upon receipt of the alert, the patient may either comply with the medication requirements, or the patient may reset the reminder for a later time (i.e., similar to a “snooze” button) 630. In addition to providing a simple reminder of the time to take a particular medication, the reminder may further provide information regarding a particular sponsor 620, as well as local relevant information (e.g., weather, sports scores, etc.) 640. In many embodiments, a global positioning chip, or other location-based data, within the user's mobile communication device may notify the administrator of a location such that the user may be provided the proper information. Such location may be used for other purposes as well, such as locating the nearest pharmacy, specialist, or the like.

A “sponsor” may be any third party wishing to advertise or provide information through the system disclosed herein. Such a sponsor may limit exposure to only certain types of reminders, for example, a sponsor may limit advertisement by therapeutic area, by medications or other combinations that may be beneficial to them. In many embodiments, the administrator of the system could sell such advertising space to a sponsor based on the number of users that such advertisement will reach, whereas the system tracks information regarding medication, condition, etc.

Returning to FIG. 5, at step 540, the user may utilize a refill alert tool. In one embodiment, the refill alert tool may remind a patient to renew a prescription a predetermined time frame prior to the end of supply. In certain embodiments, the refill reminder may comprise an interactive auto-refill tool, which may interact with a pharmacy directly to order the prescription refill (e.g., via an application programming interface through the Internet, Interactive Voice Recognition technology, or alternative means of communication).

In one exemplary embodiment, when utilizing the refill alert tool, based on the information entered by the user from the prescription label (or imported), the application may determine the date of an expected refill, the dose requirement and the days of medication supplied with that refill date. Consequently, the application identifies when the medication should be depleted and provides the user with a reminder to refill (e.g., via text message) a predetermined time (e.g., five days) prior to the supply running out.

In the following days, the application may confirm that the user has refilled the medication and is asked to enter the date of the refill. Such functionality allows the application to estimate adherence rates. For example, if there are only 30 days worth of medication, but 40 days passed before a refill date, the application can estimate that the user is running about 75% adherent (30 of 40) and may keep a month log in the database for that user. Such adherence data can also be imported from a 3rd party such as a PBM or Insurance Company.

In addition, in the exemplary embodiment, the system may interact with Pharmacy Chain IVR and Internet automated refill systems so that the user can select to substitute the refill reminder with the permission to automatically refill on their behalf with their Pharmacy Chain (or PBM). Instead of a reminder to refill, they could receive a message that the prescription has been refilled and is either in the mail or is ready to be picked up.

At step 550, the user may utilize an adherence alert tool. The adherence alert tool may track information regarding how well the user is doing with his/her adherence to prescribed medication or other medically instructed schedules. Along with an alert to the user, the adherence tracking tool may keep a compliance log for each prescription of the patient. Such adherence tracking tool may comprise certain triggers that can electronically send the log to the patient's Primary Care Physician, Pharmacist or others designated in a controlled environment.

At step 560, the user may utilize a health alert tool, also called a patient support tool. In many embodiments, with a patient support tool, the user may receive a plethora of information regarding a particular condition or disease. For example, in one embodiment, a user may receive a message, alerting them and connecting them to a health management website that provides best practices/best outcome information, social media communities (e.g., forums to discuss diseases, medications, etc.), clinical trial information for new medications, and the like. In alternative embodiments, the patient may access a “dashboard” whereby the user can immediately access all such information without the need for a periodic message.

At step 570, the user may utilize a sponsor alert tool. In many embodiments, the sponsor alert tool provides a robust marketing aspect to embodiments of the systems and methods disclosed herein. As such, in certain instances, the user may be utilizing the sponsor alert tool without knowing he/she is doing so.

In many embodiments, the sponsor alert tool may permit a sponsor to send a custom message to any segmentation of the patient population that they are sponsoring. For example, to get the user “engaged” in their adherence program, the following examples may be utilized:

### Example 1

If a particular patient segmentation is teenagers, the sponsor message can bring that audience to a custom-designed program to keep them engaged, such as a digital music website (e.g., iTunes) where they can sample songs and albums and “earn” free downloads based on their adherence. Alternatively, if the patient segmentation is one that would be “engaged” by the ability to win money.

When the sponsor brings the patient to a specified site, exemplary options are as follows: The patient may be able to: (1) read information the sponsor wishes that they read; (2) provide information that the sponsor would like to receive; (3) participate in a custom-designed program (e.g., promotions, etc.); or the like.

### Example 2

A sponsor may comprise a pharmaceutical company that makes an asthma treatment medication may know that their best “candidates” are those patients who are on high doses of a competing drug. A message to that audience can bring the patient to an Asthma Control Test (ACT) website, where they can answer questions, and such answers dictate a score and a recommendation as to whether or not they should visit a specialist (e.g., pulmonologist). A list of local specialists can pop up if the score recommends a visit, and many of those specialists are likely to recommend the sponsor's product, which would increase sales. This type of example may be a sophisticated example of the “Consumer Education” commercials seen on TV, except they can be targeted and much more effective because of their custom design components.

### Example 3

A sponsor may comprise a large pharmacy chain that provides in-store clinics for diabetes. The pharmacy chain wants patients to be adherent because they purchase more pills and visit the Pharmacy more often, increasing sales and traffic. They also gain from traffic to the other departments in the store. In this case, the sponsor may wish to send out a message to diabetics. In this case, it may be a customized invitation to join an “in-store diabetes” clinic on a certain date and time. The patient can RSVP for that date and be registered, or select another date and time, and in many embodiments, the invitation is limited to the store that the patient uses (or perhaps is local to the patient but they use a competing pharmacy).

The registration confirmation sent to the patient may comprise a “Digital Coupon” which gives a discount to diabetes-related products (part of a supplier co-op program) which is good only on that day (due to the unusually high discount). The digital coupon can be displayed on the mobile device of the user when checking out, thereby tracking all the incremental sales generated by the program. As a result, the Pharmacy may increase customer loyalty, increase Pharmacy traffic, increase general store traffic and generate additional sales.

In connection with the sponsor alert tool, there are numerous benefits for sponsors utilizing the systems and methods of embodiments of the present invention. For example, sponsor benefits may include: (1) daily branding exposure (e.g., through medication reminder tools), (2) increased patient adherence (e.g., through adherence tracking tools), (3) HIPAA compliant communication (e.g., through both the patient support tool and sponsor promotion tool), (4) increased sales (e.g., through digital coupon delivery), (5) improved market outcomes (e.g., through improved adherence) and (6) managing adverse press (e.g., through an instant ability to communicate with patients).

In many embodiments, a sponsor may control its messages to the users of the system through a dashboard. Generally, such a dashboard will allow a sponsor to select particular channels of communication with the users, allow the sponsor to dissect the market into micro-markets, and allow the sponsor to view various reports regarding data collected by the various modules disclosed herein.

At step 580, a user may utilize the personal health record tool. The personal health record tool may comprise any module that enables a compilation of the user's personal health data. In many embodiments, data for a user's personal health record (PHR) can be entered by the user or can be done by a third party having permission to enter the information. In one embodiment, the user can give a third party permission and enter the email address of the such party. That party (which may be their primary care provider), can click on a link and enter information into the record on the user's behalf.

In some embodiments, information may be entered into an insurance area (Policy Number, Group Number and Member Number), which enables the application to link up to “payer” files. Such a feature may enable the administrator to track correlations between the use of the application, the corresponding increase in adherence and the corresponding decrease in medical expenses.

In further embodiments, the data in the PHR may also enable the administrator to generate revenue from organizations (e.g., Clinical Research Organizations (CRO)) who are looking for matching profiles for candidates that may wish to participate in a clinical trial. As such, the software applications disclosed herein may become a connecting linkage between matching a patient (based on medical profile) with the CRO. Under certain circumstances, if the patient participates in the clinical trial through such a “linkage,” the CRO may pay the administrator a fee for the information.

The method 500 ends at step 590.

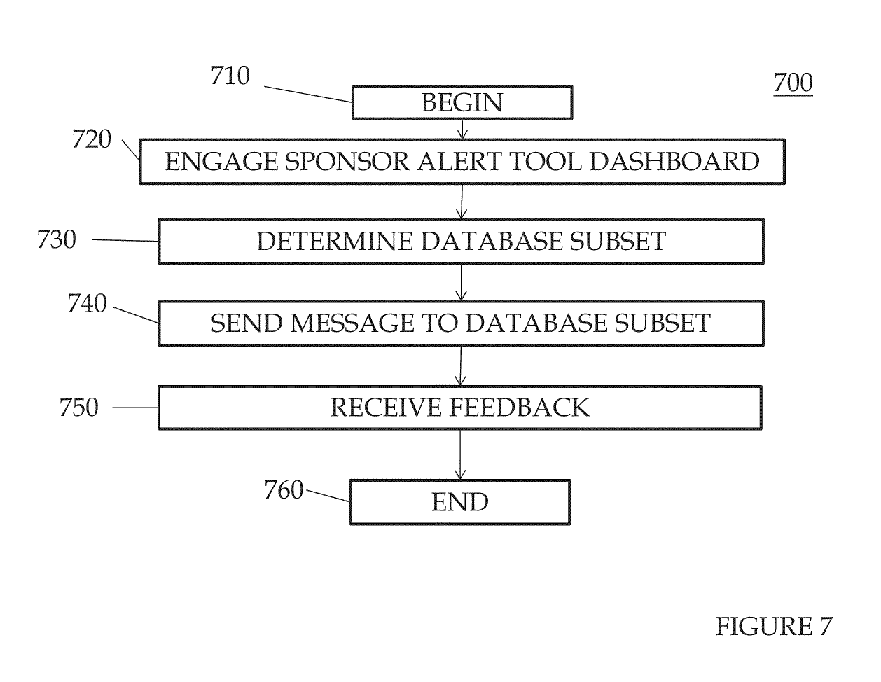

FIG. 7 depicts a flowchart of a method of marketing via a sponsor alert tool in accordance with one embodiment of the present invention. The method 700 beings at step 710. At step 720, a “sponsor” user of the system may engage a sponsor alert tool dashboard. In many embodiments, the dashboard may comprise a data portal through which the sponsor may control its marketing within the system. In such embodiments, the dashboard may allow a sponsor to log into its account within the system, access information particular to that sponsor (e.g., depending on the nature of the sponsor and its account within the system, the sponsor may have access to records, statistics, etc.), or the like.

At step 730, the sponsor may be able to select a database subset of the users of the system. In one embodiment, the database subset may comprise a subset or segment of the patient population within the system. Generally, such segment may comprise an audience that could benefit from information from the sponsor. For example, if the sponsor is a pharmaceutical company that manufactures a diabetes medication, the segment of the patients may only comprise those who currently have diabetes and/or those who are at risk of diabetes, whether or not already diagnosed. The segmentation of patient population may be done automatically by the administrator based upon the nature of the account held by the sponsor. Alternatively, the sponsor may select the types of patients it wants to reach from known information about each patient, provided by the patient/user at the time such patient signed up with the system. In yet another embodiment, other factors, such as geographical positioning, may determine the patient subset.

At step 740, the sponsor may send a message to each of the patients within the database subset. The message may generally be in the form of a voice message, text message, SMS, MMS, a multimedia message, invitations to certain events/incentives, combinations thereof, or the like. Depending on the content of the message, the sponsor may have time delay controls, such that a message may be sent on a particular day at a particular time, for example, at midnight on the day a new drug is released. The above description and examples regarding the user's perspective of the sponsor alert tool may all be conducted via the message sent by the sponsor through the sponsor alert tool dashboard.

Optionally, at step 750, the sponsor may track certain information via some type of feedback from the user. In some embodiments, the feedback may be in the form of responses to certain inquiries made in the message sent from the sponsor. In such an embodiment, the sponsor can determine the effectiveness of certain marketing efforts and make adjustments to its marketing efforts therebecause. The method 700 ends at step 760.

Although many embodiments of the present invention exist through the use of mobile devices, any type of device capable of facilitating the methods disclosed herein may be suitable. For example, adherence programs may be implemented through the SmartPhone Market (e.g., iPhone, BlackBerry, Droid), Other Mobile Phones (e.g., Website for Registration, Same Process for Rx and Reminder Collection, Mobile Phone Numbers), IVR Outbound Reminders (e.g., Outbound Calls, Press to confirm), and Non-Technical Markets (e.g., on-vial alarms, i.e., with new prescription bottles/containers, it may be possible to communicate directly with such containers).

Certain additional features may also be provided with embodiments of the present invention. In one embodiment, a user may be able to have direct access to a medical professional by the press of a button on its mobile device. In another embodiment, a user may have access to a price compare feature for certain medical costs (e.g., medication costs, insurance co-pays, etc.) In yet another embodiment, a user may be able to analyze a prescribed medication and determine whether a suitable generic exists, the prescribed medication is covered by insurance, or the like. In a further embodiment, the system may provide a medical alert feature, wherein a doctor, pharmacist or other medical professional is notified regarding any component of the systems herein upon an event occurring (e.g., adherence rates crossing a threshold, prescriptions running out, or the like.)

In many embodiments of the present invention, the administrator may be constantly collecting information and data regarding the user's activities, behaviors, participation in programs, etc. Such information may generally be collected entirely independent of the user's identity to avoid legal implications therewith. The information may be utilized for any number of purposes, including, but not limited to, data analytics to determine correlations between health and behavior.

In many embodiments of the present invention, a dynamic screen may be provided. A dynamic screen may be adapted to display the features of embodiments of the present invention and may be controlled and/or configured by a user, which may be a sponsor. In some embodiments a default sponsor name may be selected and displayed on various screens of systems of the present invention. For example, a default sponsor name may be displayed on all screens and corresponding features.

In many embodiments of the present invention, the system may allow a user to access a sponsor profile. The sponsor profile may provide a list of the items and order of the items to be displayed. If an item is not presented to a user on the user's screen, the feature may not be functional. This may enable a user to customize the application without having to develop a completely new application. In some embodiments, a default name may always be displayed, but any other name and/or logo may be selected and/or used. For example, a sponsor may choose to use the sponsor's name, logo, slogan, or the like, in place of the default name. A “terms and conditions” and/or a “privacy statement” may also be configured dynamically, thereby allowing different users and/or entities to customize these sections based on the legal requirements for that individual entity or user.

In many embodiments of the present invention, additional icons may be presented to the user, for example, at the bottom of the display. The system may enable a user to swipe a display and see the next icons, for example, the next four icons. In some embodiments, if a user swipes again an additional number of icons may be displayed. For example, an additional four icons may be displayed. The order of the icons may be determined by the sponsor.

In many embodiments of the present invention, icons and the corresponding features may include condition-related digital coupons. Condition-related coupons may be uploaded or similarly transmitted and saved on a server. Sorting of the coupons may be dynamic. In some embodiments, a system may enable changing the position of the coupons from first to second, then to second to third, or the like. A fee or premium may be paid to an administrator for a “paid coupon.” A paid coupon, or sponsored coupon, may be displayed at the top of the list when presented to a user. The user may be able to scroll down the screen to see all the coupons and may select one or more, by pressing a radio button, for example, to include the coupons they wished to use. The system may present a selectable option to finish the coupon selection. For example, at the bottom of the coupon list may be an icon, for example, an icon displayed with the text “done.”

In some embodiments, when the coupon selection is completed, for example, by selecting the “done” icon, a database may select appropriate files to attach to a communication that may be sent to the user. For example, when the coupon selection is completed, a database may select an appropriate .pdf file to attach to an email that may be sent to a user's email address. A system in accordance with embodiments of the present invention may enable a user take a coupon to a place of business. The coupon may be transported to the place of business electronically or physically, for example, by physically printing the coupon or displaying the coupon on a mobile device and presenting it to the place of business. A combination of coupons may be used together with other coupons. The coupons may print to different sizes, for example, the coupons may print three to an 8½×11 page.

In some embodiments, a “refill my prescriptions” option may be presented to a user, for example in the form of an icon. Selecting or pressing the icon may display a user's prescriptions on a display. In some embodiments, the left side of the display may comprise a selectable option, such as a radio button, that when pressed may show “included.” The system may then be adapted to interact and/or communicate with the corresponding pharmacy chain's web site for prescription refills, including the appropriate sign-on and appropriate scripting. In some embodiments, an administrator may be provided access to a screen to setup scripting, for example, IVR/telephonic or Internet access, for individual business, for example, for each pharmacy chain. If the screen is not setup, the system may be adapted to display a message to the user, for example, “Your Pharmacy Chain has not yet been setup. We will text you when it is available for your pharmacy.”

In some embodiments of the present invention, a selectable prescription price compare option and/or means may be presented to a user. In some embodiments a prescription price compare means may be adapted to provide the user a list of prices for a medication prescribed to the user, wherein each price may comprise the price of the medication prescribed to the user as offered for sale in geographic proximity to the user based on the location of a mobile device. For example, the prescription price compare option may be presented to the user via a selectable icon. Selecting and or pressing the prescription price compare icon may start a process to show the user's current prescriptions and individual and total prices for refilling all prescriptions at their current pharmacy, which may be displayed in a first column, or “column one.” A number of additional columns may also be displayed. In some embodiments four columns may be displayed reflecting the comparative pricing at pharmacy chains that are local to the user's GPS position. A hypertext phone number may be displayed next to the name along with the address of the pharmacy. This contact information may enable the user to press the phone number and call the pharmacy or enter the address into a GPS device. The contact information may also be saved in a contacts database and a particular pharmacy may be selected as a user's favorite. A favorite pharmacy may be displayed on the top of the list before any other pharmacies.

In some embodiments of the present invention, a generic alternatives option may be presented to the user. In some embodiments, the generic alternatives option may be presented to the user in the form of a selectable icon. If the generic alternatives option icon is pressed, the existing prescription drugs displayed, for example in the columns, may comprise generic alternatives. In some embodiments, the system may be adapted to display the current pharmacy price for the brand as well as the current pharmacy price for the generic alternative.

In some embodiments of the present invention, a formulary check option may be presented to the user. In some embodiments, the formulary check option may be presented to the user in the form of a selectable icon. When the formulary check option is selected, the system may be adapted to use information in a PHR section and may display a screen showing, for example, in column one, the existing medications. In some embodiments, a second column, column two, may display a therapeutic category. in some embodiments, a third column, column three, may display in formulary or not in formulary. In some embodiments, a fourth column, column four, may display medications in formulary for that therapeutic area for a payer.

In some embodiments of the present invention an “ask the pharmacist” option may be presented to the user. In some embodiments, the “ask the pharmacist” option may be presented to the user in the form of a selectable icon. When ask the pharmacist option is selected, the system may be adapted to queue up an email screen, or the like, addressed to the email address of the sponsoring pharmacist pool. The system may be adapted to allow a user to select, for example, via a title from the drop down menu, a subject of the email. In some embodiments, a “misc.” option may be included as a selectable subject line or a default subject line for the email. After the email screen is displayed to the user, system may be adapted to allow the user to type a question to a pharmacist. A time requirement may be imposed for response. For example, the pharmacist pool may be responsible to reply to the questions within a specified time period, for example, 48 hours. In some embodiments, the system may be adapted to automatically answer questions that have approved answers in a library.

In some embodiments of the present invention, a venue unlock option may be presented to the user. In some embodiments, the venue unlock option may be presented to the user in the form of a selectable icon. In some embodiments, the system may be adapted to drive customers to a particular venue. The system may be adapted to allow a pharmacy department to unlock additional features for the user and record the “unlocks” to show that the system is driving traffic to a venue.

In some embodiments, the system may be adapted to present a promo code screen, which may ask a user to enter a code, for example, a five digit promo code, enabling the user to receive digital coupons and/or services associated with the promo code. In some embodiments, the user may be provided the option to skip this step. if the user skips this step, the system may be adapted to automatically enter in a default code, for example, 00000, which may enable an administrator to send a sponsor alert to attempt to obtain that information afterwards.

Certain conditions such as diabetes have recommended preventative checkups, such as an A1C test every three months, retina exam, etc. In some embodiments, the system may be adapted to provide reminders for preventative checkups. For example, the system may be adapted to, in predetermined periods, provide reminders for preventative checkups. For example, the system may be adapted to, every 3 months: remind A, B, C, D; every 6 months: remind A, E; and every year: remind B, F, with the letters indicating different types of preventative tests. By providing reminders for preventative checkups, the system may better help in managing the various conditions and the associated checkups, etc. that each condition warrants. In some embodiments, an administrative screen may be used to enter the data for each condition. The administrative screen may be adapted to show a timeline whereby an administrator may select a timeframe, for example, 1 month, 2 months, etc. and a reminder type in the reminder message to be transmitted and/or displayed to the user.

In many embodiments of the present invention, the system may be adapted to provide age related reminders. In some embodiments, the system may check the age of the patient and automatically send a reminder when an age dependent checkup may be performed. For instance, if male, the system may be adapted to send a reminder on a user's birthday, such as a user's 50th birthday, to get a colonoscopy, or the like. The system may also be adapted to provide additional age-related reminders. For example, in five year intervals from a user's 50th birthday, or the date of a colonoscopy entered into the system, the system may be adapted to send a reminder “time to schedule your colonoscopy.”

In some embodiments of the present invention, a system may be adapted to provide a virtual marketing option to a user. At selected intervals, the system may be adapted to provide sponsored alerts to a user. For example, the system may be adapted to provide a sponsored alert every three months. A sponsored alert may comprise a communication, such as a text, voicemail, email, snail mail, and/or the like. The sponsored alert may suggest that a user recommend the system or another product or service to friends or family. The system may be adapted to provide an option to recommend the system to another person. For example, a hypertext may be used to present an option that, when selected, may trigger sending a communication to a second user to enable the second user to access the system.

In some embodiments of the present invention, an option may be presented to a user to provide an issue and/or explanation of a problem with adherence. For example, for non-adherent patients, a sponsor alert communication/text may be sent to a user to enable the user to access a location where the issue can be addressed, for example, a website. In some embodiments, the system may be adapted to enable a sponsor to identify other issues with the system and for an administrator to address the issues that are important to them.

In some embodiments, a health alert and/or sponsor alert option may be provided to the user. For example, if a smartphone user is in dormant mode, a health alert or sponsor alert message will show when the phone is activated, but it may no longer direct the user to a designated web address. In some embodiments, the system may be adapted to access and/or display a designated web page so that when the phone is activated, the designated web page is displayed. In some embodiments, the server may queue an email to a predetermined email address for processing. In some embodiments, a number of files, for example, two files may be attached for each sponsor alert and/or health alert. The first attached file may comprise a sponsor alert or health alert text message. The second file may comprise an email addresses of the target audience compiled for the sponsor alert and/or health alert message. In some embodiments, the administrator may forward that email to a selected email campaign management company. In some embodiments, a batch process may be automated and configured to be consistent with the requirements of an email campaign management company.

Although most of the embodiments disclosed herein are directed to medication adherence, alternative embodiments of the present may utilize similar tools for various industries. For example, embodiments of the present invention may be utilized in the property and casualty insurance industry, where accidents, claims, premiums, etc. are tracked. In another example, embodiments may be utilized in the automotive insurance industry, tracking driving records, specialty-training courses for inclement weather, etc. In yet another example, embodiments may be utilized with financial industries, tracking credit scores, timeliness of payments, etc.

While the foregoing is directed to embodiments of the present invention, other and further embodiments of the invention may be devised without departing from the basic scope thereof. Furthermore, whereas the multitude of embodiments disclosed herein each provides a variety of elements within each embodiment, it should be appreciated any combination of elements from any combination of embodiments is well within the scope of further embodiments of the present invention.

What is claimed is:

1. A method of increasing medication adherence rates comprising:
enabling a user to download an application to a mobile device via a network, the application comprising a set of instructions for permitting a user to access:
a medication reminder means for providing a reminder to the user to follow prescribed instructions regarding a medication for a medical condition and allowing a user to provide customization data, the customization data comprising at least one of an indication of a reminder frequency, a reminder transmission format, a reminder sound, and a reminder content;
an adherence tracking means for tracking the user's compliance with the prescribed instructions, wherein the adherence tracking means permits a user to provide information via the mobile device regarding the user's reasons for non-adherence;
a patient support means for providing the user access to social media communities and information pertaining to one of the medication, the medical condition or treatment thereof;
a sponsor alert means for providing portions of the data to a third party sponsor, and permitting the sponsor to engage in marketing or advertising; and
a prescription price compare means adapted to provide the user a list of prices for a medication prescribed to the user, each price comprising the price of the medication prescribed to the user as offered for sale in geographic proximity to the user based on the location of the mobile device;
receiving data from the mobile device at a remote server via the network, the data comprising information from the adherence tracking means;
wherein the adherence tracking means credits the user with a reward for compliance, the reward comprising at least one of rewards points redeemable for a product or a service, or a coupon redeemable for a product or a service; and
wherein the sponsor alert means comprises a sponsor-accessible dashboard, with which the sponsor may identify a set of users from a plurality of users within a system, including the user, and directly communicate marketing or advertising content with the user via the mobile device at a time and frequency selected by the sponsor through the dashboard, and wherein the marketing or advertising content comprises at least a link to a third-party website related to one of the sponsor, the medication, or the medical condition.
